(19) United States
(12) Patent Application Publication
(10) Pub. No.: US 2003/0046394 A1
(43) Pub. Date: Mar. 6, 2003

(54) SYSTEM AND METHOD FOR AN APPLICATION SPACE SERVER CLUSTER

(76) Inventors: Mr. Steve Goddard, Lincoln, NE (US); Mr. Byravamurthy Ramamurthy, Lincoln, NE (US); Mr. Xuehong Gan, Seattle, WA (US)

Correspondence Address: James J. Barta, Jr., Frank R. Agovino, Senniger Powers Leavitt & Roedel, One Metropolitan Square, 16th Floor, St. Louis, Missouri, 63102, US

(21) Appl. No.: 09/878,787

(22) Filed: Jun. 11, 2001

Related U.S. Application Data
(60) Provisional application No. 60/245,790, filed on Nov. 3, 2001.
(60) Provisional application No. 60/245,789, filed on Nov. 3, 2000.
(60) Provisional application No. 60/245,788, filed on Nov. 3, 2000.
(60) Provisional application No. 60/245,859, filed on Nov. 3, 2000.

(51) Int. Cl. G06F 15/16

(52) U.S. Cl. 709/226; 709/105; 709/251

(57) ABSTRACT

### Abstract of the Disclosure

A system and method for implementing a scalable, application-space, highly-available server cluster. The system demonstrates high performance and fault tolerance using application-space software and commercial-off-the-shelf hardware and operating systems. The system includes an application-space dispatch server that performs various switching methods, including L4/2 switching or L4/3 switching. The system also includes state reconstruction software and token-based protocol software. The protocol software supports self-configuring, detecting and adapting to the addition or removal of network servers. The system offers a flexible and cost-effective alternative to kernel-space or hardware-based clustered web servers with performance comparable to kernel-space implementations.

### Cross Reference to Related Applications

This application claims the benefit of co-pending United States Provisional patent application Serial No. 60/245,790, entitled THE SASHA CLUSTER BASED WEB SERVER, filed November 3, 2000, United States Provisional patent application Serial No. 60/245,789, entitled ASSURED QOS REQUEST SCHEDULING, filed November 3, 2000, United States Provisional patent application Serial No. 60/245,788, entitled RATE-BASED RESOURCE ALLOCATION (RBA) TECHNOLOGY, filed November 3, 2000, and United States Provisional patent application Serial No. 60/245,859, entitled ACTIVE SET CONNECTION MANAGEMENT, filed November 3, 2000. The entirety of such provisional patent applications are hereby incorporated by reference herein.

### Background of the Invention

1. Field of the Invention

The present invention relates to the field of computer networking. In particular, this invention relates to a method and system for server clustering.

2. Description of the Prior Art

The exponential growth of the Internet, coupled with the increasing popularity of dynamically generated content on the World Wide Web, has created the need for more and faster web servers capable of serving the over 100 million Internet users. One solution for scaling server capacity has been to completely replace the old server with a new server. This expensive, short-term solution requires discarding the old server and purchasing a new server.

A pool of connected servers acting as a single unit, or server clustering, provides incremental scalability. Additional low-cost servers may gradually be added to augment the performance of existing servers. Some clustering techniques treat the cluster as an indissoluble whole rather than a layered architecture assumed by fully transparent clustering. Thus, while transparent to end users, these clustering systems are not transparent to the servers in the cluster. As such, each server in the cluster requires software or hardware specialized for that server and its particular function in the cluster. The cost and complexity of developing such specialized and often proprietary clustering systems is significant. While these proprietary clustering systems provide improved performance over a single-server solution, these clustering systems cannot provide flexibility and low cost.

Furthermore, to achieve fault tolerance, some clustering systems require additional, dedicated servers to provide hot-standby operation and state replication for critical servers in the cluster. This effectively doubles the cost of the solution. The additional servers are exact replicas of the critical servers. Under non-faulty conditions, the additional servers perform no useful function. Instead, the additional servers merely track the creation and deletion of potentially thousands of connections per second between each critical server and the other servers in the cluster.

For information relating to load sharing using network address translation, refer to P. Srisuresh and D. Gan, "Load Sharing Using Network Address Translation," The Internet Society, Aug. 1998, incorporated herein by reference.

### Summary of the Invention

It is an object of this invention to provide a method and system which implements a scalable, highly available, high performance network server clustering technique.

It is another object of this invention to provide a method and system which takes advantage of the price/performance ratio offered by commercial-off-the-shelf hardware and software while still providing high performance and zero downtime.

It is another object of this invention to provide a method and system which provides the capability for any network server to operate as a dispatcher server.

It is another object of this invention to provide a method and system which provides the ability to operate without a designated standby unit for the dispatch server.

It is another object of this invention to provide a method and system which is self-configuring in detecting and adapting to the addition or removal of network servers.

It is another object of this invention to provide a method and system which is flexible, portable, and extensible.

It is another object of this invention to provide a method and system which provides a high performance web server clustering solution that allows use of standard server configurations.

It is another object of this invention to provide a method and system of server clustering which achieves comparable performance to kernel-based software solutions while simultaneously allowing for easy and inexpensive scaling of both performance and fault tolerance.

In one form, the invention includes a system responsive to client requests for delivering data via a network to a client. The system comprises at least one dispatch server, a plurality of network servers, dispatch software, and protocol software. The dispatch server receives the client requests. The dispatch software executes in application-space on the dispatch server to selectively assign the client requests to the network servers. The protocol software executes in application-space on the dispatch server and each of the network servers. The protocol software interrelates the dispatch server and network servers as ring members of a logical, token-passing, fault-tolerant ring network. The plurality of network servers are responsive to the dispatch software and the protocol software to deliver the data to the clients in response to the client requests.

In another form, the invention includes a system responsive to client requests for delivering data via a network to a client. The system comprises at least one dispatch server, a plurality of network servers, dispatch software, and protocol software. The dispatch server receives the client requests. The dispatch software executes in application-space on the dispatch server to selectively assign the client requests to the network servers. The system is structured according to an Open Source Interconnection (OSI) reference model. The dispatch software performs switching of the client requests at layer 4 of the OSI reference model. The protocol software executes in application-space on the dispatch server and each of the network servers. The protocol software interrelates the dispatch server and network servers as ring members of a logical, token-passing, fault-tolerant ring network. The plurality of network servers are responsive to the dispatch software and the protocol software to deliver the data to the clients in response to the client requests.

In yet another form, the invention includes a system responsive to client requests for delivering data via a network to a client. The system comprises at least one dispatch server receiving the client requests, a plurality of network servers, dispatch software, and protocol software. The dispatch software executes in application-space on the dispatch server to selectively assign the client requests to the network servers. The system is structured according to an Open Source Interconnection (OSI) reference model. The dispatch software performs switching of the client requests at layer 7 of the OSI reference model and then performs switching of the client requests at layer 3 of the OSI reference model. The protocol software executes in application-space on the dispatch server and each of the network servers. The protocol software organizes the dispatch server and network servers as ring members of a logical, token-passing, ring network. The protocol software detects a fault of the dispatch server or the network servers. The plurality of network servers are responsive to the dispatch software and the protocol software to deliver the data to the clients in response to the client requests.

In yet another form, the invention includes a method for delivering data to a client in response to client requests for said data via a network having at least one dispatch server and a plurality of network servers. The method comprises the steps of:

receiving the client requests;

selectively assigning the client requests to the network servers after receiving the client requests;

delivering the data to the clients in response to the assigned client requests;

organizing the dispatch server and network servers as ring members of a logical, token-passing, ring network;

detecting a fault of the dispatch server or the network servers;

and recovering from the fault.

In yet another form, the invention includes a system for delivering data to a client in response to client requests for said data via a network having at least one dispatch server and a plurality of network servers. The system comprises means for receiving the client requests. The system also comprises means for selectively assigning the client requests to the network servers after receiving the client requests. The system also comprises means for delivering the data to the clients in response to the assigned client requests. The system also comprises means for organizing the dispatch server and network servers as ring members of a logical, token-passing, ring network. The system also comprises means for detecting a fault of the dispatch server or the network servers. The system also comprises means for recovering from the fault.

Other objects and features will be in part apparent and in part pointed out hereinafter.

### Brief Description of the Drawings

FIG. 1 is a block diagram of one embodiment of the method and system of the invention illustrating the main components of the system.

FIG. 2 is a block diagram of one embodiment of the method and system of the invention illustrating assignment by the dispatch server to the network servers of client requests for data.

FIG. 3 is a block diagram of one embodiment of the method and system of the invention illustrating servicing by the network servers of the assigned client requests for data in an L4/2 cluster.

FIG. 4 is a block diagram of one embodiment of the method and system of the invention illustrating an exemplary data flow in an L4/2 cluster.

FIG. 5 is block diagram of one embodiment of the method and system of the invention illustrating servicing by the network servers of the assigned client requests for data in an L4/3 cluster.

FIG. 6 is a block diagram of one embodiment of the method and system of the invention illustrating an exemplary data flow in an L4/3 cluster.

FIG. 7 is a flow chart of one embodiment of the method and system of the invention illustrating operation of the dispatch software.

FIG. 8 is a flow chart of one embodiment of the method and system of the invention illustrating assignment of client request by the dispatch software.

FIG. 9 is a flow chart of one embodiment of the method and system of the invention illustrating operation of the protocol software.

FIG. 10 is a block diagram of one embodiment of the method and system of the invention illustrating packet transmission among the ring members.

FIG. 11 is a flow chart of one embodiment of the method and system of the invention illustrating packet transmission among the ring members via the protocol software.

FIG. 12 is a block diagram of one embodiment of the method and system of the invention illustrating ring reconstruction.

FIG. 13 is a block diagram of one embodiment of the method and system of the invention illustrating the seven layer Open Source Interconnection reference model.

Corresponding reference characters indicate corresponding parts throughout the drawings.

### Brief Description of the Appendix

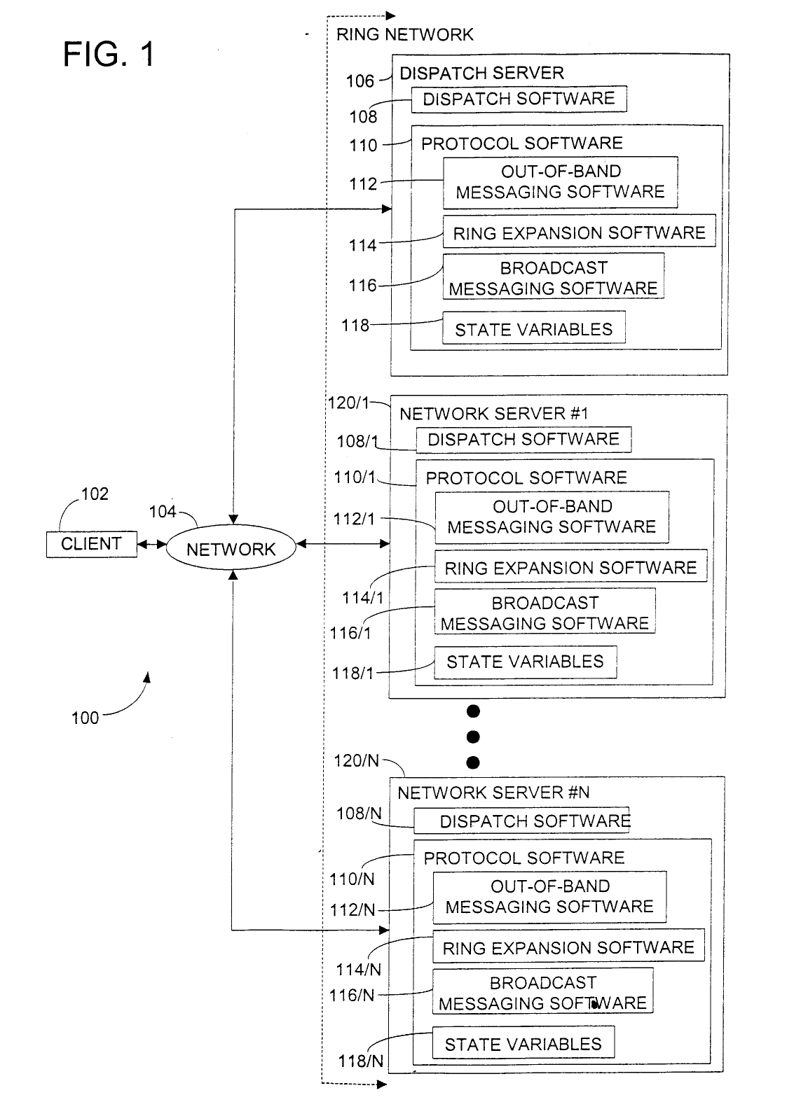

Appendix A, figure 1A illustrates the level of service provided during the fault detection and recovery interval for each of the failure modes.

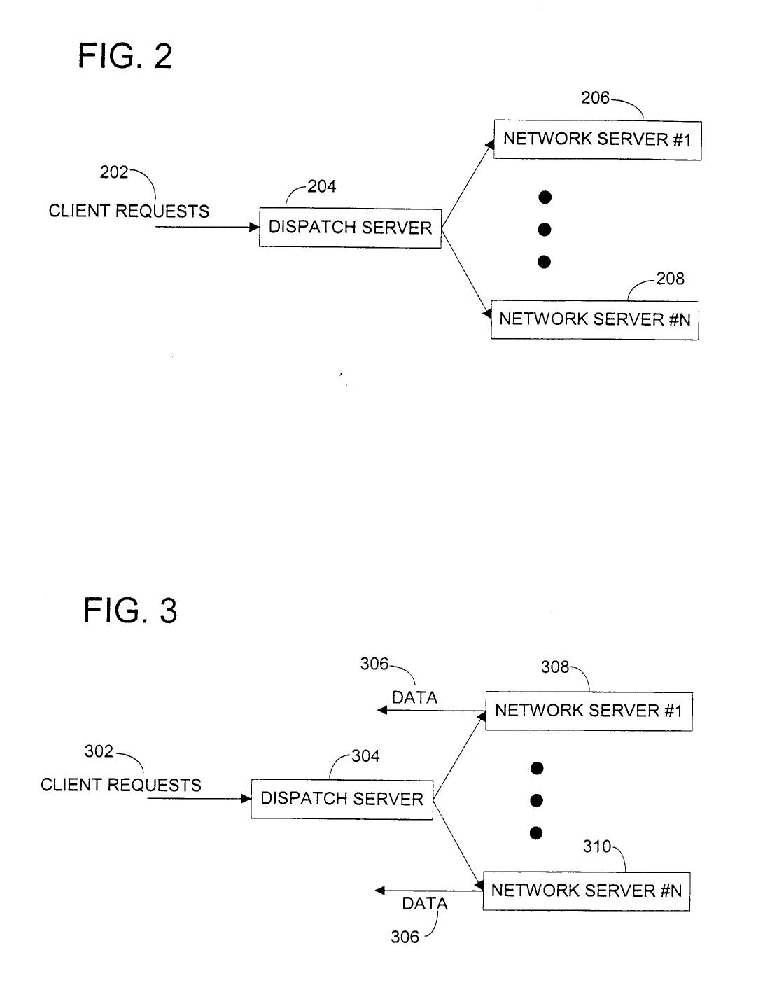

Appendix A, figure 2A compares the requests serviced per second versus the requests received per second.

### Detailed Description of the Preferred Embodiments

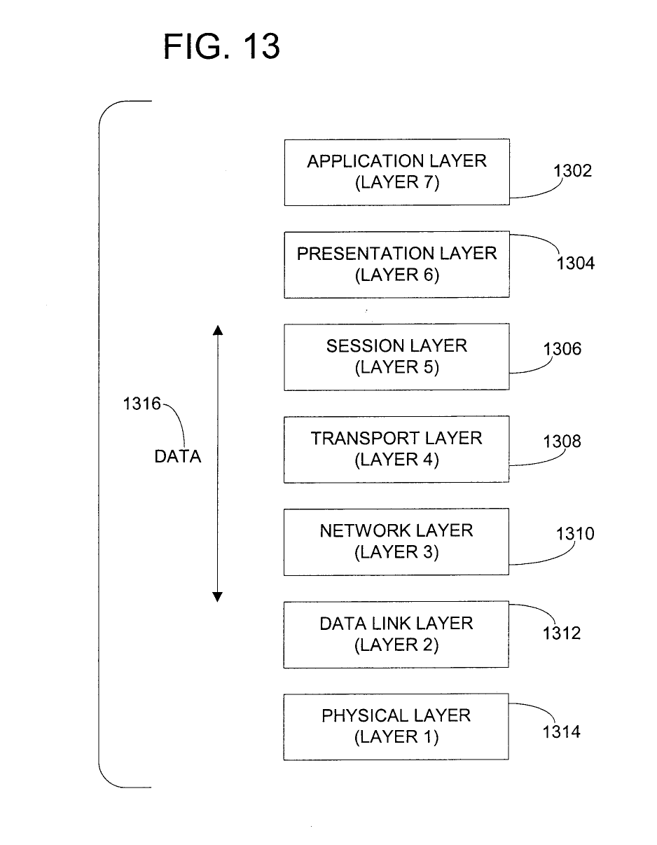

The terminology used to describe server clustering mechanisms varies widely. The terms include clustering, application-layer switching, layer 4-7 switching, or server load balancing. Clustering is broadly classified as one of three particular categories named by the level(s) of the Open Source Interconnection (OSI) protocol stack (see Figure 13) at which they operate: layer four switching with layer two address translation (L4/2), layer four switching with layer three address translation (L4/3), and layer seven (L7) switching. Address translation is also referred to as packet forwarding. L7 switching is also referred to as content-based routing.

In general, the invention is a system and method (hereinafter "system 100") that implements a scalable, application-space, highly-available server cluster. The system 100 demonstrates high performance and fault tolerance using application-space software and commercial-off-the-shelf (COTS) hardware and operating systems. The system 100 includes a dispatch server that performs various switching methods in application-space, including L4/2 switching or L4/3 switching. The system 100 also includes application-space software that executes on network servers to provide the capability for any network server to operate as the dispatch server. The system 100 also includes state reconstruction software and token-based protocol software. The protocol software supports self-configuring, detecting and adapting to the addition or removal of network servers. The system 100 offers a flexible and cost-effective alternative to kernel-space or hardware-based clustered web servers with performance comparable to kernel-space implementations.

Software on a computer is generally separated into operating system (OS) software and applications. The OS software typically includes a kernel and one or more libraries. The kernel is a set of routines for performing basic, low-level functions of the OS such as interfacing with hardware. The applications are typically high-level programs that interact with the OS software to perform functions. The applications are said to execute in application-space. Software to implement server clustering can be implemented in the kernel, in applications, or in hardware. The software of the system 100 is embodied in applications and executes in application-space. As such, in one embodiment, the system 100 utilizes COTS hardware and COTS OS software.

Referring first to Figure 1, a block diagram illustrates the main components of the system 100. A client 102 transmits a client request for data via a network 104. For example, the client 102 may be an end user navigating a global computer network such as the Internet, and selecting content via a hyperlink. In this example, the data is the selected content. The network 104 includes, but is not limited to, a local area network (LAN), a wide area network (WAN), a wireless network, or any other communications medium. Those skilled in the art will appreciate that the client 102 may request data with various computing and telecommunications devices including, but not limited to, a personal computer, a cellular telephone, a personal digital assistant, or any other processor-based computing device.

A dispatch server 106 connected to the network 104 receives the client request. The dispatch server 106 includes dispatch software 108 and protocol software 110. The dispatch software 108 executes in application-space to selectively assign the client request to one of a plurality of network servers 120/1, 120/N. A maximum of N network servers 120/1, 120/N are connected to the network 104. Each network server 120/1, 120/N has the dispatch software 108 and the protocol software 110.

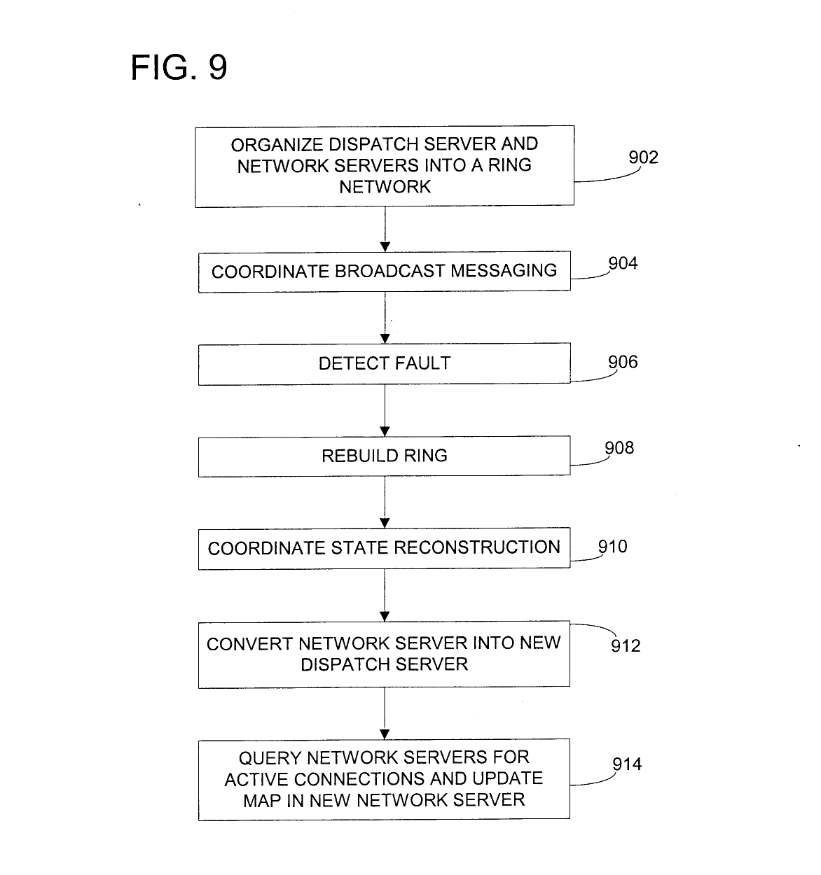

The dispatch software 108 is executed on each network server 120/1, 120/N only when that network server 120/1, 120/N is elected to function as another dispatch server (see Figure 9). The protocol software 110 executes in application-space on the dispatch server 106 and each of the network servers 120/1, 120/N to interrelate or otherwise organize the dispatch server 106 and network servers 120/1, 120/N as ring members of a logical, token-passing, fault-tolerant ring network. The protocol software 110 provides fault-tolerance for the ring network by detecting a fault of the dispatch server 106 or the network servers 120/1, 120/N and facilitating recovery from the fault. The network servers 120/1, 120/N are responsive to the dispatch software 108 and the protocol software 110 to deliver the requested data to the client 102 in response to the client request. Those skilled in the art will appreciate that the dispatch server 106 and the network servers 120/1, 120/N can include various hardware and software products and configurations to achieve the desired functionality. The dispatch software 108 of the dispatch server 106 corresponds to the dispatch software 108/1, 108/N of the network servers 120/1, 120/N, where N is a positive integer.

The protocol software 110 includes out-of-band messaging software 112 coordinating creation and transmission of tokens by the ring members. The out-of-band messaging software 112 allows the ring members to create and transmit new packets (tokens) instead of waiting to receive the current packet (token). This allows for out-of-band messaging in critical situations such as failure of one of the ring members. The protocol software 110 includes ring expansion software 114 adapting to the addition of a new network server to the ring network. The protocol software 110 also includes broadcast messaging software 116 or other multicast or group messaging software coordinating broadcast messaging among the ring members. The protocol software 110 includes state variables 118. The state variables 118 stored by the protocol software 110 of a specific ring member only include an address associated with the specific ring member, the numerically smallest address associated with one of the ring members, the numerically greatest address associated with one of the ring members, the address of the ring member that is numerically greater and closest to the address associated with the specific ring member, the address of the ring member that is numerically smaller and closest to the address associated with the specific ring member, a broadcast address, and a creation time associated with creation of the ring network.

In various embodiments of the system 100, the protocol software 110 of the system 100 essentially replaces the hot standby replication unit of other clustering systems. The system 100 avoids the need for active state replication and dedicated standby units. The protocol software 110 implements a connectionless, non-reliable, token-passing, group messaging protocol. The protocol software 110 is suitable for use in a wide range of applications involving locally interconnected nodes. For example, the protocol software 110 is capable of use in distributed embedded systems, such as Versa Module Europa (VME) based systems, and collections of autonomous computers connected via a LAN. The protocol software 110 is customizable for each specific application allowing many aspects to be determined by the implementor. The protocol software 110 of the dispatch server 106 corresponds to the protocol software 110/1, 110/N of the network servers 120/1, 120/N.

Referring next to Figure 2, a block diagram illustrates assignment by the dispatch server 204 to the network servers 206, 208 of client requests 202 for data. The dispatch server 204 receives the client requests 202, and assigns the client requests 202 to one of the N network servers 206, 208. The dispatch server 204 selectively assigns the client requests 202 according to various methods implemented in software executing in application-space. Exemplary methods include, but are not limited to, L4/2 switching, L4/3 switching, and content-based routing.

Referring next to Figure 3, a block diagram illustrates servicing by the network servers 308, 310 of the assigned client requests 302 for data in an L4/2 cluster. The dispatch server 304 receives the client requests 302, and assigns the client requests 302 to one of the N network servers 308, 310. In one embodiment, the system 100 is structured according to the OSI reference model (see Figure 13). The dispatch server 504 selectively assigns the clients requests 302 to the network server 308, 310 by performing switching of the client requests 302 at layer 4 of the OSI reference model and translating addresses associated the client requests 302 at layer 2 of the OSI reference model.

In such an L4/2 cluster, the network servers 308, 310 in the cluster are identical above OSI layer two. That is, all the network servers 308, 310 share a layer three address (a network address), but each network server 308, 310 has a unique layer two address (a media access control, or MAC, address). In L4/2 clustering, the layer three address is shared by the dispatch server 304 and all of the network servers 308, 310 through the use of primary and secondary Internet Protocol (IP) addresses. That is, while the primary address of the dispatch server 304 is the same as a cluster address, each network server 308, 310 is configured with the cluster address as the secondary address. This may be done through the use of interface aliasing or by changing the address of the loopback device on the network servers 308, 310. The nearest gateway in the network is then configured such that all packets arriving for the cluster address are addressed to the dispatch server 304 at layer two. This is typically done with a static Address Resolution Protocol (ARP) cache entry.

If the client request 302 corresponds to a transmission control protocol/Internet protocol (TCP/IP) connection initiation, the dispatch server 304 selects one of the network servers 308, 310 to service the client request 302. Network server 308, 310 selection is based on a load sharing algorithm such as round-robin. The dispatch server 304 then makes an entry in a connection map, noting an origin of the connection, the chosen network server, and other information (e.g., time) that may be relevant. A layer two destination address of the packet containing the client request 302 is then rewritten to the layer two address of the chosen network server, and the packet is placed back on the network. If the client request 302 is not for a connection initiation, the dispatch server 304 examines the connection map to determine if the client request 302 belongs to a currently established connection. If the client request 302 belongs to a currently established connection, the dispatch server 304 rewrites the layer two destination address to be the address of the network server as defined in the connection map. In addition, if the dispatch server 304 has different input and output network interface cards (NICs), the dispatch server 304 rewrites a layer two source address of the client request 302 to reflect the output NIC. The dispatch server 304 transmits the packet containing the client request 302 across the network. The chosen network server receives and processes the packet. Replies are sent out via the default gateway. In the event that the client request 302 does not correspond to an established connection and is not a connection initiation packet, the client request 302 is dropped. Upon processing the client request 302 with a TCP FIN+ACK bit set, the dispatch server 304 deletes the connection associated with the client request 302 and removes the appropriate entry from the connection map.

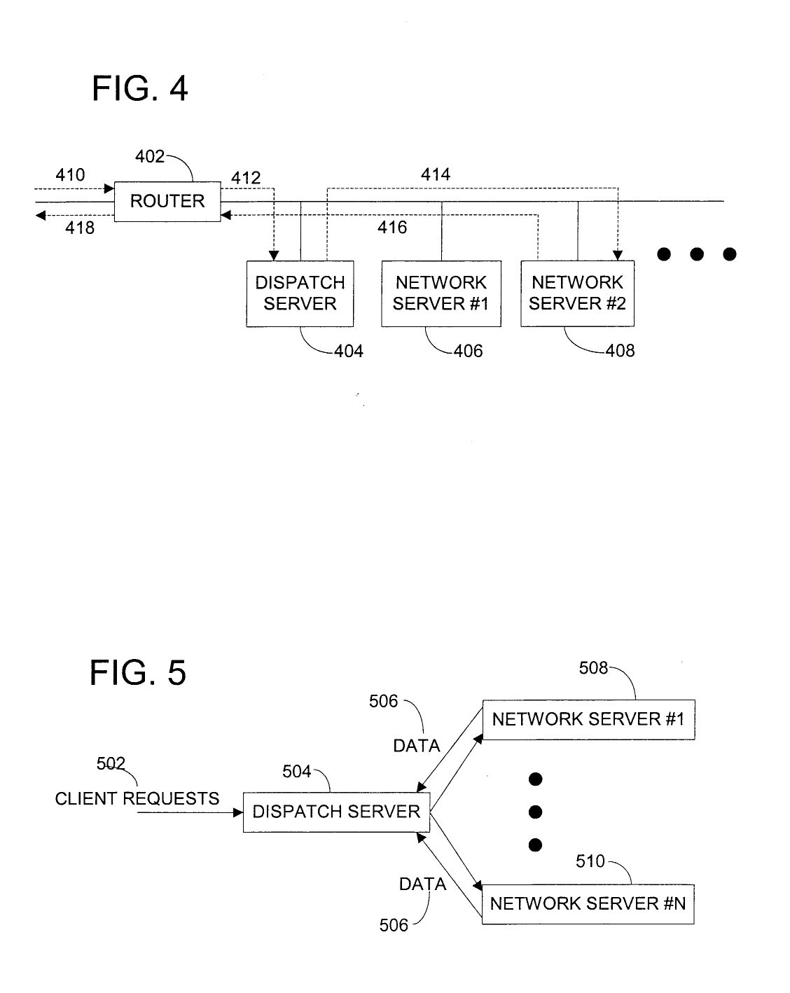

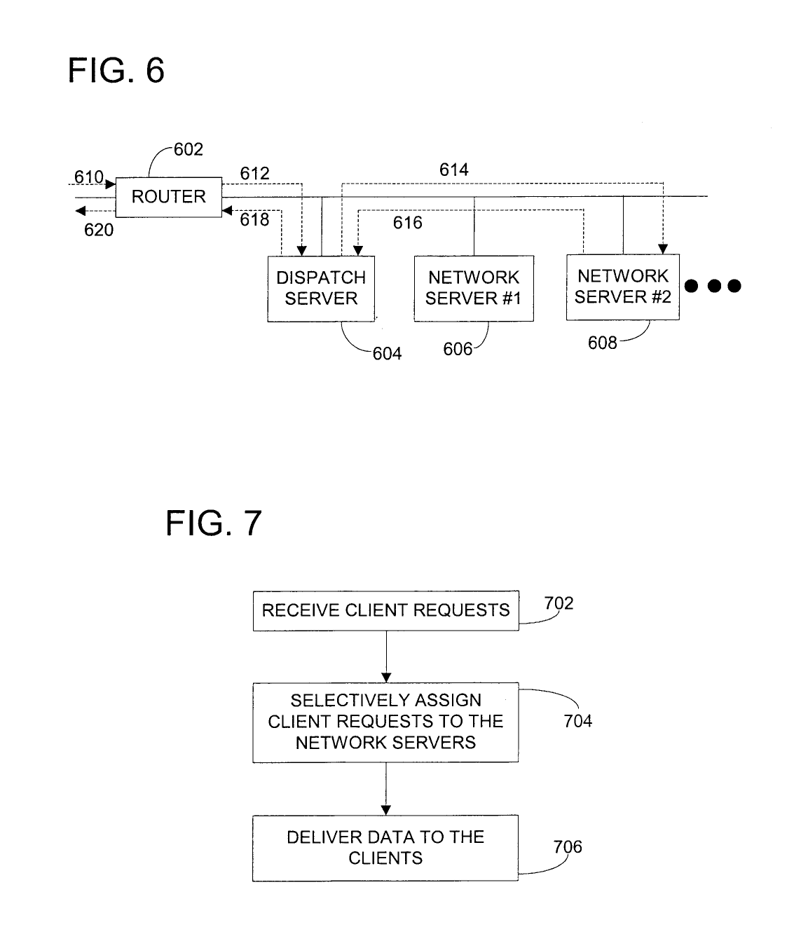

Those skilled in the art will note that in some embodiments, the dispatch server will have one connection to a WAN such as the Internet and one connection to a LAN such as an internal cluster network. Each connection requires a separate NIC. It is possible to run the dispatcher with only a single NIC, with the dispatch server and the network servers connected to a LAN that is connected to a router to the WAN (see generally Figures 4 and 6). Those skilled in the art will note that the systems and methods of the invention are operable in both single NIC and multiple NIC environments. When only one NIC is present, the hardware destination address of the incoming message becomes the hardware source address of the outgoing message.

An example of the operation of the dispatch server 304 in an L4/2 cluster is as follows. When the dispatch server 304 receives a SYN TCP/IP message indicating a connection request from a client over an Ethernet LAN, the Ethernet (L2) header information identifies the dispatch server 304 as the hardware destination and the previous hop (a router or other network server) as the hardware source. For example, in a network where the Ethernet address of the dispatch server 304 is 0:90:27:8F:7:EB, a hardware destination address associated with the message is 0:90:27:8F:7:EB and a hardware source address is 0:B2:68:F1:23:5C. The dispatch server 304 makes a new entry in the connection map, selects one of the network servers to accept the connection, and rewrites the hardware destination and source addresses (assuming the message is sent out a different NIC than from which it was received). For example, in a network where the Ethernet address of the selected network server is 0:60:EA:34:9:6A and the Ethernet address of the output NIC of the dispatch server 304 is 0:C0:95:E0:31:1D, the hardware destination address of the message would be re-written as 0:60:EA:34:9:6A and the hardware source address would be re-written as 0:C0:95:E0:31:1D. The message is transmitted after a device driver for the output NIC updates a checksum field. No other fields of the message are modified (i.e., the IP source address which identifies the client). All other messages for the connection are forwarded from the client to the selected network server in the same manner until the connection is terminated. Messages from the selected network server to the client do not pass through the dispatch server 304 in an L4/2 cluster.

Those skilled in the art will appreciate that the above description of the operation of the dispatch server 304 and actual operation may vary yet accomplish the same result. For example, the dispatch server 304 may simply establish a new entry in the connection map for all packets that do not map to established connections, regardless of whether or not they are connection initiations.

Referring next to Figure 4, a block diagram illustrates an exemplary data flow in an L4/2 cluster. A router 402 or other gateway associated with the network receives at 410 the client request generated by the client. The router 402 directs at 412 the client request to the dispatch server 404. The dispatch server 404 selectively assigns at 414 the client request to one of the network servers 406, 408 based on a load sharing algorithm. In Figure 4, the dispatch server 404 assigns the client request to network server #2 408. The dispatch server 404 transmits the client request to network server #2 408 after changing the layer two address of the client request to the layer two address of network server #2 408. In addition, prior to transmission, if the dispatch server 404 has different input and output NICs, the dispatch server 404 rewrites a layer two source address of the client request to reflect the output NIC. Network server #2 408, responsive to the client request, delivers at 416 the requested data to the client via the router 402 at 418 and the network.

Referring next to Figure 5, a block diagram illustrates servicing by the network servers 508, 510 of the assigned client requests 502 for data in an L4/3 cluster. The dispatch server 504 receives the client requests 502, and assigns the client requests 502 to one of the N network servers 508, 510. In one embodiment, the system 100 is structured according to the OSI reference model (see Figure 13). The dispatch server 504 selectively assigns the clients requests 502 to the network servers 508, 510 by performing switching of the client requests 502 at layer 4 of the OSI reference model and translating addresses associated the client requests 502 at layer 3 of the OSI reference model. The network servers 508, 510 deliver the data to the client via the dispatch server 504.

In such an L4/3 cluster, the network servers 508, 510 in the cluster are identical above OSI layer three. That is, unlike an L4/2 cluster, each network server 508, 510 in the L4/3 cluster has a unique layer three address. The layer three address may be globally unique or merely locally unique. The dispatch server 504 in an L4/3 cluster appears as a single host to the client. That is, the dispatch server 504 is the only ring member assigned the cluster address. To the network servers 508, 510, however, the dispatch server 504 appears as a gateway. When the client requests 502 are sent from the client to the cluster, the client requests 502 are addressed to the cluster address. Utilizing standard network routing rules, the client requests 502 are delivered to the dispatch server 504.

If the client request 502 corresponds to a TCP/IP connection initiation, the dispatch server 504 selects one of the network servers 508, 510 to service the client request 502. Similar to an L4/2 cluster, network server 508, 510 selection is based on a load sharing algorithm such as round-robin. The dispatch server 504 also makes an entry in the connection map, noting the origin of the connection, the chosen network server, and other information (e.g., time) that may be relevant. However, unlike the L4/2 cluster, the layer three address of the client request 502 is then re-written as the layer three address of the chosen network server. Moreover, any integrity codes such as packet checksums, cyclic redundancy checks (CRCs), or error correction checks (ECCs) are recomputed prior to transmission. The modified client request is then sent to the chosen network server. If the client request 502 is not a connection initiation, the dispatch server 504 examines the connection map to determine if the client request 502 belongs to a currently established connection. If the client request 502 belongs to a currently established connection, the dispatch server 504 rewrites the layer three address as the address of the network server defined in the connection map, recomputes the checksums, and forwards the modified client request across the network. In the event that the client request 502 does not correspond to an established connection and is not a connection initiation packet, the client request 502 is dropped. As with L4/2 dispatching, approaches may vary.

Replies to the client requests 502 sent from the network servers 508, 510 to the clients travel through the dispatch server 504 since a source address on the replies is the address of the particular network server that serviced the request, not the cluster address. The dispatch server 504 rewrites the source address to the cluster address, recomputes the integrity codes, and forwards the replies to the client.

The invention does not establish an L4 connection with the client directly. That is, the invention only changes the destination IP address unless port mapping is required for some other reason. This is more efficient than establishing connections between the dispatch server 504 and the client and the dispatch server 504 and the network servers, which is required for L7. To make sure that the return traffic from the network server to the client goes back through the dispatch server 504, the dispatch server 504 is identified as the default gateway for each network server. Then the dispatch server receives the messages, changes the source IP address to its own IP address and sends the message to the client via a router.

An example of the operation of the dispatch server 504 in an L4/3 cluster is as follows. When the dispatch server 504 receives a SYN TCP/IP message indicating a connection request from a client over the network, the IP (L3) header information identifies the dispatch server 504 as the IP destination and the client as the IP (L3) source. For example, in a network where the IP address of the dispatch server 504 is 192.168.6.2 and the IP address of the client is 192.168.2.14, the IP destination address of the message is 192.168.6.2 and the IP source address of the message is 192.168.2.14. The dispatch server 504 makes a new entry in the connection map, selects one of the network servers to accept the connection, and rewrites the IP destination address. For example, in a network where the IP address of the selected network server is 192.168.3.22, the IP destination address of the message is re-written to 192.168.3.22. Since the destination address in the IP header has been changed, the header checksum parameter of the IP header is re-computed. The message is then output using a raw socket provided by the host operating system. Thus, the host operating system software encapsulates the IP message in an Ethernet frame (L2 message) and the message is sent to the destination server following normal network protocols. All other messages for the connection are forwarded from the client to the selected network server in the same manner until the connection is terminated.

Messages from the selected network server to the client must pass through the dispatch server 504 in an L4/3 cluster. When the dispatch server 504 receives a TCP/IP message from the selected network server over the network, the IP header information identifies the client (dispatch server 504) as the IP destination and the selected network server as the IP source. For example, in a network where the IP address of the client is 192.168.2.14 and the IP address of the selected network server is 192.168.3.22, the IP destination address of the message is 192.168.2.14 and the IP source address of the message is 192.168.3.22. The dispatch server 504 rewrites the IP source address. For example, in a network where the IP address of the dispatch server 504 is 192.168.6.2, the IP source address of the message is re-written to 192.168.6.2.

Since the source address in the IP header has been changed, the header checksum parameter of the IP header is recomputed. The message is then output using a raw socket provided by the host operating system. Thus, the host operating system software encapsulates the IP message in an Ethernet frame (L2 message) and the message is sent to the client following normal network protocols. All other messages for the connection are forwarded from the server to the client in the same manner until the connection is terminated.

In an alternative embodiment, the dispatch server 504 selectively assigns the clients requests 502 to the network server 508, 510 by performing switching of the client requests 502 at layer 7 of the OSI reference model and then performs switching of the client requests 502 either at layer 2 or at layer 3 of the OSI reference model. This is also known as content-based dispatching since it operates based on the contents of the client request 502. The dispatch server 504 examines the client request 502 to ascertain the desired object of the client request 502 and routes the client request 502 to the appropriate network server 508, 510 based on the desired object. For example, the desired object of a specific client request may be an image. After identifying the desired object of the specific client request as an image, the dispatch server 504 routes the specific client request to the network server that has been designated as a repository for images.

In the L7 cluster, the dispatch server 504 acts as a single point of contact for the cluster. The dispatch server 504 accepts the connection with the client, receives the client request 502, and chooses an appropriate network server based on information in the client request 502. After choosing a network server, the dispatch server 504 employs layer three switching (see Figure 5) to forward the client request 502 to the chosen network server for servicing. Alternatively, with a change to the operating system or the hardware driver to support TCP handoff, the dispatch server 504 could employ layer two switching (see Figure 3) to forward the client request 502 to the chosen network server for servicing.

An example of the operation of the dispatch server 504 in an L7 cluster is as follows. When the dispatch server 504 receives a SYN TCP/IP message indicating a connection request from a client over the network, the IP (L3) header information identifies the dispatch server 504 as the IP destination and the client as the IP source. For example, in a network where the IP address of the dispatch server 504 is 192.168.6.2 and the IP address of the client is 192.168.2.14, the IP destination address of the message is 192.168.6.2 and the IP source address of the message is 192.168.2.14. The TCP (L4) header information identifies the source and destination ports (as well as other information). For example, the TCP destination port of the dispatch server 504 is 80, and the TCP source port of the client is 1069. The dispatch server 504 makes a new entry in the connection map and establishes the TCP/IP connection with the client following the normal TCP/IP protocol with the exception that the protocol software is executed in application space by the dispatch server 504 rather than in kernel space by the host operating system.

Depending on the connection management technology used between the dispatch server 504 and the selected network server, either a new L7 connection is established with the selected network server or an existing L7 connection will be used to send L7 requests from the newly established L4 connection between the client and the dispatch server 504. The L7 requests from the client are encapsulated in subsequent L4 messages associated with the connection established between the dispatch server 504 and the client. When an L7 request is received, the dispatch server 504 selects a network server to accept the connection (if it has not already done so), and rewrites the IP destination and source addresses of the request. For example, in a network where the IP address of the selected network server is 192.168.3.22 and the IP address of the dispatch server 504 is 192.168.3.1, the IP destination address of the message is re-written to be 192.168.3.22 and the IP source address of the message is re-written to be 192.168.3.1.

The TCP (L4) source and destination ports (as well as other protocol information) must also be modified to match the connection between the dispatch server 504 and the server. For example, the TCP destination port of the selected network server is 80 and the TCP source port of the dispatch server 504 is 12689.

Since the destination and source addresses in the IP header have been changed, the header checksum parameter of the IP header is re-computed. Since the TCP source port in the TCP header has been changed, the header checksum parameter of the TCP header is also re-computed. The message is then transmitted using a raw socket provided by the host operating system. Thus, the host operating system software encapsulates the L7 message in an Ethernet frame (L2 message) and the message is sent to the destination server following normal network protocols. All other requests for the connection are forwarded from the client to the server in the same manner until the connection is terminated.

Messages from the network server to the client must pass through the dispatch server 504 in an L7/3 cluster. When the dispatch server 504 receives an L7 reply from a network server over the network, the IP header information identifies the dispatch server 504 as the IP destination and the server as the IP source. For example, in a network where the IP address of the dispatch server 504 is 192.168.3.1 and the IP address of the network server is 192.168.3.22, the IP destination address is 192.168.3.1 and the IP source address is 192.168.3.22. The TCP source and destination ports (as well as other protocol information) reflect the connection between the dispatch server 504 and the server. For example, the TCP destination port of the dispatch server 504 is 12689 and the TCP source port of the network server is 80. The dispatch server 504 rewrites the IP source and destination addresses of the message. For example, in a network where the IP address of the client is 192.168.2.14 and the IP address of the dispatch server 504 is 192.168.6.2, the IP destination address of the message is re-written to be 192.168.2.14 and the IP source address of the message is re-written to be 192.168.6.2. The dispatch server 504 must also rewrite the destination port (as well as other protocol information). For example, the TCP destination port is re-written to 1069 and the TCP source port is 80.

Since the source and destination addresses in the IP header have been changed, the header checksum parameter of the IP header is re-computed. Since the TCP destination port in the TCP header has been changed, the header checksum parameter of the TCP header is also re-computed. The message is then transmitted using a raw socket provided by the host operating system. Thus, the host operating system software encapsulates the IP message in an Ethernet frame (L2 message) and the message is sent to the client following normal network protocols. All other messages for the connection are forwarded from the server to the client in the same manner until the connection is terminated.

Referring next to Figure 6, a block diagram illustrates an exemplary data flow in an L4/3 cluster. A router 602 or other gateway associated with the network receives at 610 the client request. The router 602 directs at 612 the client request to the dispatch server 604. The dispatch server 604 selectively assigns at 614 the client request to one of the network servers 606, 608 based on the load sharing algorithm. In Figure 6, the dispatch server 604 assigns the client request to network server #2 608. The dispatch server 604 transmits the client request to network server #2 608 after changing the layer three address of the client request to the layer three address of network server #2 608 and recalculating the checksums. Network server #2 608, responsive to the client request, delivers at 616 the requested data to the dispatch server 604. Network server #2 608 views the dispatch server 604 as a gateway. The dispatch server 604 rewrites the layer three source address of the reply as the cluster address and recalculates the checksums. The dispatch server 604 forwards at 618 the data to the client via the router at 620 and the network.

Referring next to Figure 7, a flow chart illustrates operation of the dispatch software. The dispatch server receives at 702 the client requests. The dispatch server selectively assigns at 704 the client requests to the network servers after receiving the client requests. In L4/3 and L7 networks, the network servers transmit the data to the dispatch server in response to the assigned client requests. The dispatch server receives the data from the network servers and delivers at 706 the data to the clients. In other networks (e.g., L4/2), the network servers deliver the data directly to the clients (see Figure 3). The dispatch server and network servers are interrelated as ring members of the ring network. A fault of the dispatch server or the network servers can be detected. A fault by the dispatch server or one or more of the network servers includes cessation of communication between the failed server and the ring members. A fault may include failure of hardware and/or software associated with the uncommunicative server. Broadcast messaging is required for two or more faults. For single fault detection and recovery, the packets can travel in reverse around the ring network.

In one embodiment, the dispatch software includes caching (e.g., layer 7). The caching is tunable to adjust the delivery of the data to the client whereby a response time to specific client requests is reduced and the load on the network servers is reduced. If the data specified by the client request is in the cache, the dispatch server delivers the data to the client without involving the network servers.

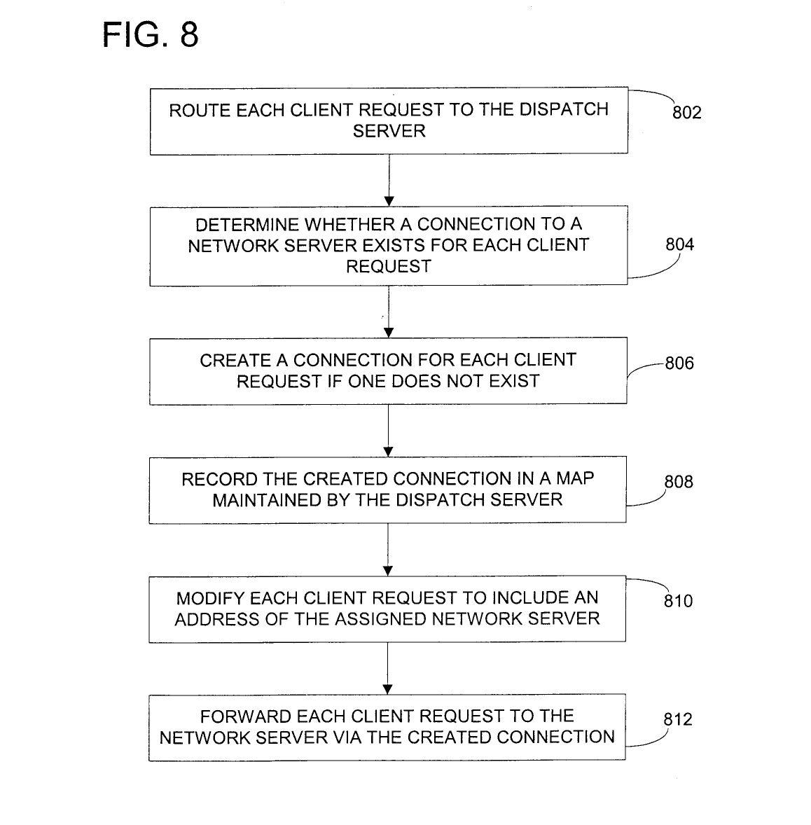

Referring next to Figure 8, a flow chart illustrates assignment of client request by the dispatch software. Each client request is routed at 802 to the dispatch server. The dispatch software determines at 804 whether a connection to one of the network servers exists for each client request. The dispatch software creates at 806 the connection to a specific network server if the connection does not exist. The connection is recorded at 808 in a map maintained by the dispatch server. Each client request is modified at 810 to include an address of the specific network server associated with the created connection. Each client request is forwarded at 812 to the specific network server via the created connection.

Referring next to Figure 9, a flow chart illustrates operation of the protocol software. The protocol software interrelates at 902 the dispatch server and each of the network servers as the ring members of the ring network. The protocol software also coordinates at 904 broadcast messaging among the ring members. The protocol software detects at 906 and recovers from at least one fault by one or more of the ring members. The ring network is rebuilt at 908 without the faulty ring member. The protocol software comprises reconstruction software to coordinate at 910 state reconstruction after fault detection. Coordinating state reconstruction includes directing the dispatch software, which executes in application-space on each of the network servers, to functionally convert at 912 one of the network servers into a new dispatch server after detecting a fault with the dispatch server. In an L4/2 or L4/3 cluster, the new dispatch server queries at 914 the network servers for a list of active connections and enters the list of active connections into a connection map associated with the new dispatch server.

When the dispatch server fails in an L4/2 or L4/3 cluster, state reconstruction includes reconstructing the connection map containing the list of connections. Since the address of the client in the packets containing the client requests remains unchanged by the dispatch server, the network servers are aware of the IP addresses of their clients. In one embodiment, the new dispatch server queries the network servers for the list of active connections and enters the list of active connections into the connection map. In another embodiment, the network servers broadcast a list of connections maintained prior to the fault in response to a request (e.g., by the new dispatch server). The new dispatch server receives the list of connections from each network server. The new dispatch server updates the connection map maintained by the new dispatch server with the list of connections from each network server.

When the dispatch server fails in an L7 cluster, state reconstruction includes rebuilding, not reconstructing, the connection map. Since the packets containing the client requests have been re-written by the dispatch server to identify the dispatch server as the source of the client requests, the network servers are not aware of the addresses of their clients. When the dispatch server fails, the connection map is re-built after the client requests time out, the clients re-send the client requests, and the new dispatch server re-builds the connection map.

If a network server fails in an L7 cluster, the dispatch server recreates the connections of the failed network server with other network servers. Since the dispatch server stores connection information in the connection map, the dispatch server knows the addresses of the clients of the failed network server. In L4/3 and L4/2 networks, all connections established with the failed server are lost.

In one embodiment, the faults are symmetric-omissive. That is, we assume that all failures cause the ring member to stop responding and that the failures manifest themselves to all other ring members in the ring network. This behavior is usually exhibited in the event of operating system crashes or hardware failures. Other fault modes could be tolerated with additional logic, such as acceptability checks and fault diagnoses. For example, all hypertext transfer protocol (HTTP) response codes other than the 200 family imply an error and the ring member could be taken out of the ring network until repairs are completed. The fault-tolerance of the system 100 refers to the aggregate system. In one embodiment, when one of the ring members fails, all requests in progress on the failed ring member are lost. This is the nature of the HTTP service. No attempt is made to complete the in-progress requests using another ring member.

Detecting and recovering from the faults includes detecting the fault by failing to receive communications such as packets from the faulty ring member during a communications timeout interval. The communications timeout interval is configurable. Without the ability to bound the time taken to process a packet, the communications timeout interval must be experimentally determined. For example, at extremely high loads, it may take the ring member more than one second to receive, process, and transmit packets. Therefore, the exemplary communications timeout interval is 2,000 milliseconds (ms).

If one of the network servers fails, the ring network is broken in that packets do not propagate from the failed network server. In one embodiment, this break is detected by the lack of packets and a ring purge is forced. Upon detecting the ring purge, the dispatch server marks all the network servers as inactive. The protocol software of the detecting ring member broadcasts a request to all the ring members to leave and reenter the ring network. The status of each network server is changed to active as the network server re-joins the ring network. The ring network re-forms without the faulty network server. In this fashion, network server failures are automatically detected and masked. Rebuilding the ring is also referred to as ring reconstruction.

If the faulty ring member is the dispatch server, a new dispatch server is identified during a broadcast timeout interval from one of the ring members in the rebuilt ring network. The ring is deemed reconstructed after the broadcast timeout interval has expired. An exemplary broadcast timeout interval is 2,500 ms. A new dispatch server is identified in various ways. In one embodiment, a new dispatch server is identified by selecting one of the ring members in the rebuilt ring network with the numerically smallest address in the ring network. Other methods for electing the new dispatch server include selecting the broadcasting ring member with the numerically smallest, largest, N-i smallest, or N-i largest address in the ring to be the new dispatch server, where N is the maximum number of network servers in the ring network and i corresponds to the ith position in the ring network. However, in a heterogeneous environment of network servers with different capabilities (the capability to act as a network server, the capability to act as a dispatch server, etc.), the elected dispatch server might be disqualified if it does not have the capability to act as a dispatch server. In this case, the next eligible ring member is selected as the new dispatch server. If the failed dispatch server rejoins the ring network at a later time, the two dispatch servers will detect each other and the dispatch server with the higher address will abdicate and become a network server. This mechanism may be extended to support scenarios where more than two dispatch servers have been elected, such as in the event of network partition and rejoining.

The potential for each network server to act as the new dispatch server indicates that the available level of fault tolerance is equal to the number of ring members in the ring network. In one embodiment, one ring member is the dispatch server and all the other ring members operate as network servers to improve the aggregate performance of the system 100. In the event of one or more faults, a network server may be elected to be the dispatch server, leaving one less network server. Thus, increasing numbers of faults gracefully degrades the performance of the system 100 until all ring members have failed. In the event that all ring members but one have failed, the remaining ring member operates as a standalone network server instead of becoming the new dispatch server.

The system 100 adapts to the addition of a new network server to the ring network via the ring expansion software (see Figure 1, reference character 114). If a new network server is available, the new network server broadcasts a packet containing a message indicating an intention to join the ring network. The new network server is then assigned an address by the dispatch server or other ring member and inserted into the ring network.

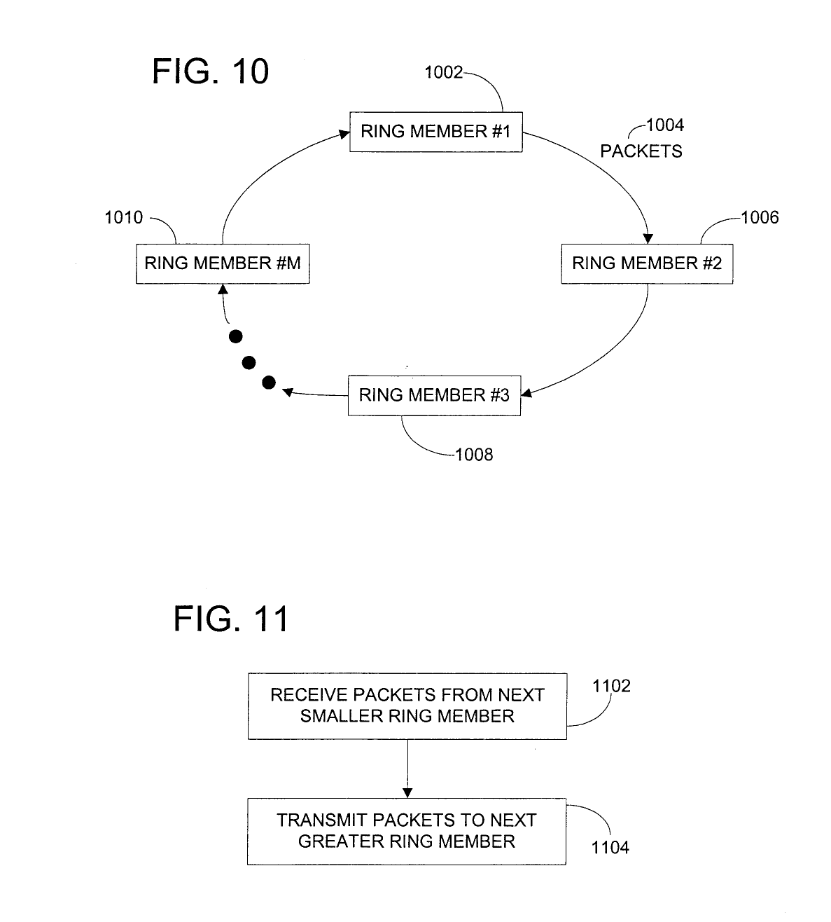

Referring next to Figure 10, a block diagram illustrates packet transmission among the ring members. A maximum of M ring members are included in the ring network, where M is a positive integer. Ring member #1 1002 transmits packets 1004 to ring member #2 1006. Ring member #2 1006 receives the packets 1004 from ring member #1 1002, and transmits the packets 1004 to ring member #3 1008. This process continues up to ring member #M 1010. Ring member #M 1010 receives the packets 1004 from ring member #(M-1) and transmits the packets 1004 to ring member #1 1002. Ring member #2 1006 is referred to as the nearest downstream neighbor (NDN) of ring member #1 1002. Ring member #1 1002 is referred to as the nearest upstream neighbor (NUN) of ring member #2 1006. Similar relationships exist as appropriate between the other ring members.

The packets 1004 contain messages. In one embodiment, each packet 1004 includes a collection of zero or more messages plus additional headers. Each message indicates some condition or action to be taken. For example, the messages might indicate a new network server has entered the ring network. Similarly, each of the client requests is represented by one or more of the packets 1004. Some packets include a self-identifying heartbeat message. As long as the heartbeat message circulates, the ring network is assumed to be free of faults. In the system 100, a token is implicit in that the token is the lower layer packet 1004 carrying the heartbeat message. Receipt of the heartbeat message indicates that the nearest transmitting ring member is functioning properly. By extension, if the packet 1004 containing the heartbeat message can be sent to all ring members, all nearest receiving ring members are functioning properly and therefore the ring network is fault-free.

A plurality of the packets 1004 may simultaneously circulate the ring network. In the system 100, there is no limit to the number of packets 1004 that may be traveling the ring network at a given time. The ring members transmit and receive the packets 1004 according to the logical organization of the ring network as described in Figure 11. If any message in the packet 1004 is addressed only to the ring member receiving the packet 1004 or if the message has expired, the ring member removes the message from the packet 1004 before sending the packet to the next ring member. If a specific ring member receives the packet 1004 containing a message originating from the specific ring member, the specific ring member removes that message since the packet 1004 has circulated the ring network and the intended recipient of the message either did not receive the message or did not remove it from the packet 1004.

Referring next to Figure 11, a flow chart illustrates packet transmission among the ring members via the protocol software. In one embodiment, each specific ring member receives at 1102 the packets from a ring member with an address which is numerically smaller and closest to an address of the specific ring member. Each specific ring member transmits at 1104 the packets to a ring member with an address which is numerically greater and closest to the address of the specific ring member. A ring member with the numerically smallest address in the ring network receives the packets from a ring member with the numerically greatest address in the ring network. The ring member with the numerically greatest address in the ring network transmits the packets to the ring member with the numerically smallest address in the ring network.

Those skilled in the art will note that the ring network can be logically interrelated in various ways to accomplish the same results. The ring members in the ring network can be interrelated according to their addresses in many ways, including high to low and low to high. The ring network is any L7 ring on top of any lower level network. The underlying protocol layer is used as a strong ordering on the ring members. For example, if the protocol software communicates at OSI layer three, IP addresses are used to order the ring members within the ring network. If the protocol software communicates at OSI layer two, a 48-bit MAC address is used to order the ring members within the ring network. In addition, the ring members can be interrelated according to the order in which they joined the ring such first-in first-out, first-in last-out, etc. In one embodiment, the ring member with the numerically smallest address is a ring master. The duties of the ring master include circulating packets including a heartbeat message when the ring network is fault-free and executing at-most-once operations, such as ring member identification assignment. In addition, the protocol software can be implemented on top of various LAN architectures such as ethernet, asynchronous transfer mode or fiber distributed data interface.

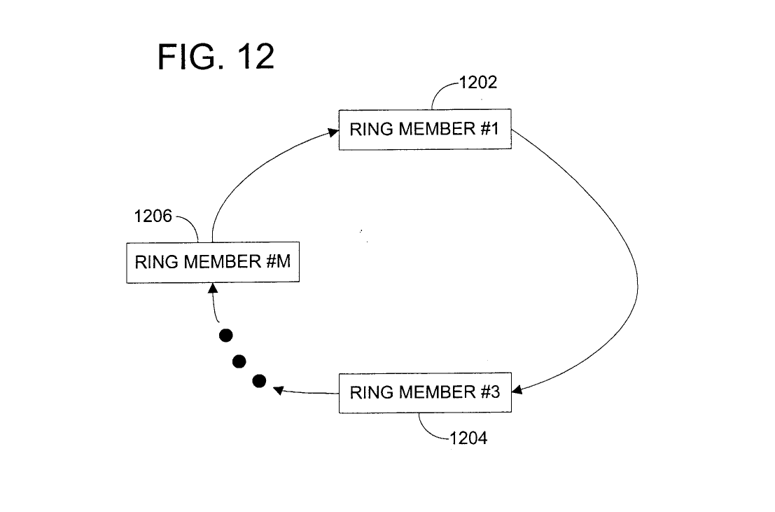

Referring next to Figure 12, a block diagram illustrates the results of ring reconstruction. A maximum of M ring members are included in the ring network. Ring member #2 has faulted and been removed from the ring during ring reconstruction (see Figure 9). As a result of ring reconstruction, ring member #1 1202 transmits the packets to ring member #3 1204. That is, ring member #3 1204 is now the NDN of ring member #1 1202. This process continues up to ring member #M 1206. Ring member #M 1206 receives the packets from ring member #(M-1) and transmits the packets to ring member #1 1202. In this manner, ring reconstruction adapts the system 100 to the failure of one of the ring members.

Referring next to Figure 13, a block diagram illustrates the seven layer OSI reference model. The system 100 is structured according to a multi-layer reference model such as the OSI reference model. The protocol software communicates at any one of the layers of the reference model. Data 1316 ascends and descends through the layers of the OSI reference model. Layers 1-7 include, respectively, a physical layer 1314, a data link layer 1312, a network layer 1310, a transport layer 1308, a session layer 1306, a presentation layer 1304, and an application layer 1302.

An exemplary embodiment of the system 100 is described below. Each client is an Intel Pentium II 266 with 64 or 128 megabytes (MB) of random access memory (RAM) running Red Hat Linux 5.2 with version 2.2.10 of the Linux kernel. Each network server is an AMD K6-2 400 with 128 MB of RAM running Red Hat Linux 5.2 with version 2.2.10 of the Linux kernel. The dispatch server is either a server similar to the network servers or a Pentium 133 with 32 MB of RAM and a similar software configuration. All the clients have ZNYX 346 100 megabits per second Ethernet cards. The network servers and the dispatch server have Intel EtherExpress Pro/100 interfaces. All servers have a dedicated switch port on a Cisco 2900 XL Ethernet switch. Appendix A contains a summary of the performance of this exemplary embodiment under varying conditions.

The following example illustrates the addition of a network server into the ring network in a TCP/IP environment. In this example, the ring network has three network servers with IP addresses of 192.168.1.2, 192.168.1.5, and 192.168.1.6. The IP addresses are used as a strong ordering for the ring network: 192.168.1.5 is the NDN of 192.168.1.2, 192.168.1.6 is the NDN of 192.168.1.5, and 192.168.1.2 is the NDN of 192.168.1.6.

The additional network server has an IP address of 192.168.1.4. In one embodiment, the additional network server broadcasts a message indicating that its address is 192.168.1.4. Each ring member responds with messages indicating their IP address. At the same time, the 192.168.1.2 network server identifies the additional network server as numerically closer than the 192.168.1.5 network server. The 192.168.1.2 network server modifies its protocol software so that the additional network server 192.168.1.4 is the NDN of the 192.168.1.2 network server. The 192.168.1.5 network server modifies its protocol software so that the additional network server is the NUN of the 192.168.1.5 network server. The additional network server has the 192.168.1.2 network server as the NUN and the 192.168.1.5 network server as the NDN. In this fashion, the ring network adapts to the addition and removal of network servers.

A minimal packet generated by the protocol software includes IP headers, user datagram protocol (UDP) headers, a packet header and message headers (nominally four bytes) for a total of 33 bytes. The packet header typically represents the amount of messages within the packet.

In another example, a minimal hardware frame for network transmission includes a four byte heartbeat message plus additional headers. The additional headers include a one byte source address, a one byte destination address, and a two byte checksum. If there are 254 ring members, the number of bytes transmitted is 254 * (4 + 4) = 2032 bytes for each heartbeat message that circulates. This requirement is sufficiently small such that embedded processors could process each heartbeat message with minimal demand in resources.

In one embodiment of the system 100, the dispatch server operates in the context of web servers. Those skilled in the art will appreciate that many other services are suited to the implementation of clustering as described herein and require little or no changes to the described cluster architecture. All components of the system 100 execute in application-space and are not necessarily connected to any particular hardware or software component. One ring member will operate as the dispatch server and the rest of the ring members will operate as network servers. While some ring members might be specialized (e.g., lacking the ability to operate as a dispatch server or lacking the ability to operate as a network server), in one embodiment any ring member can be either one of the network servers or the dispatch server. Moreover, the system 100 is not limited to a particular processor family and may take advantage of any architecture necessary to implement the system 100. For example, any computing device from a low-end PC to the fastest SPARC or Alpha systems may be used. There is nothing in the system 100 which mandates one particular dispatching approach or prohibits another.

In one embodiment, the protocol software and dispatch software in the system 100 are written using a packet capture library such as libpcap, a packet authoring library such as Libnet, and portable operating system (POSIX) threads. The use of these libraries and threads provides the system 100 with maximum portability among UNIX compatible systems. In addition, the use of libpcap on any system which uses a Berkeley Packet Filter (BPF) eliminates one of the drawbacks to an application-space cluster: BPF only copies those packets which are of interest to the user-level application and ignores all others. This method reduces packet copying penalties and the number of switches between user and kernel modes. However, those skilled in the art will note that the protocol software and the dispatch software can be implemented in accordance with the system 100 using various software components and computer languages.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

### Appendix A

This section evaluates experimental results obtained from a prototype of the SASHA architecture. We consider the results of tests in various fault scenarios under various loads.

Our results demonstrate that in tests of real-world (and some not-so-real-world) scenarios, our SASHA architecture provides a high level of fault tolerance. In some cases, faults might go unnoticed by users since they are detected and masked before they make a significant impact on the level of service. Our fault-tolerance experiments are structured around three levels of service requested by client browsers: 2500 connections per second (cps), 1500 cps, and 500 cps. At each requested level of service, we measured performance for the following fault scenarios: no-faults, a dispatcher server faults, three server faults, and four server faults. Figure 1A summarizes the actual level of service provided during the fault detection and recovery interval for each of the failure modes. In each fault scenario, the final level of service was higher than the level of service provided during the detection and recovery process. The rest of this section details these experiments as well as the final level of service provided after fault recovery.

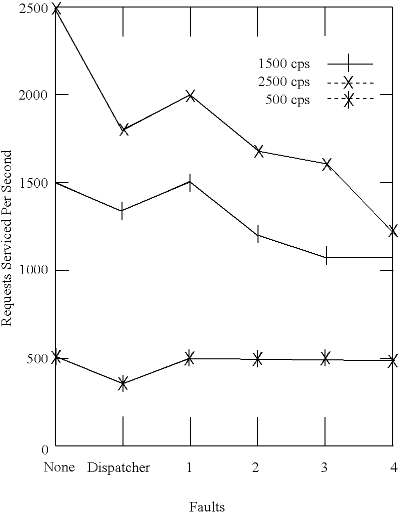

### 2,500 Connections Per Second

In the first case, we examined the behavior of a cluster consisting of five server nodes and the K6-2 400 dispatcher. Each of our five clients generated 500 requests per second. This was the maximum sustainable load for our clients and servers, though dispatcher utilization suggests that it may be capable of supporting up to 3,300 connections per second. Each test ran for a total of 30 seconds. This short duration allows us to more easily discern the effects of node failure. Figure 1A shows that in the base, non-faulty, case we are capable of servicing 2,465 connections per second.

In the first fault scenario, the dispatcher node was unplugged from the network shortly after beginning the test. We see that the average connection rate drops to 1,755 connections per second (cps). This is to be expected, given the time taken to purge the ring and detect the dispatcher's absence. Following the startup of a new dispatcher, throughput returned to 2,000 cps, or5 of the original rate. Again, this is not surprising as the servers were operating at capacity previously and thus losing one of five nodes drops the performance to 80% of its previous level.

Next we tested a single-fault scenario. In this case, shortly after starting the test, we removed a server from the network. Results were slightly better than expected. Factoring in the connections allocated to the server before its loss was detected and given the degraded state of the system following diagnosis, we still managed to average 2,053 connections per second.

In the next scenario, we examined the impact of coincident faults. The test was allowed to get underway and then one server was taken offline. After the system had detected and diagnosed, the next server was taken offline. Again, we see a nearly linear performance decrease in performance as the connection rate drops to 1,691 cps. The three fault scenario was similar to the two fault scenario, save that performance ends up being 1,574 cps. This relatively high performance-given that there are, at the end of the test, only two active servers-is most likely due to the fact that the state of the server gradually degrades over the course of the test. We see similar behavior with a four fault scenario. By the end of the four fault test, performance had stabilized at just over 500 cps, the maximum sustainable load for a single server.

### 1,500 Connections Per Second

This test was similar to the 2,500 cps test, but with the servers less utilized. This allows us to observe the behavior of the system in fault-scenarios where we have excess server capacity. In this configuration, the base, no-fault, case shows 1,488 cps. As we have seen above, the servers are capable of servicing a total of 2,500 cps, therefore the cluster is only 60% utilized. Similar to the 2,500 cps test, we first removed the dispatcher midway through the test. Again performance drops, as expected-to 1,297 cps in this case. However, owing to the excess capacity in the clustered server, by the end of the test, performance had returned to 1,500 cps. For this reason, the loss and election of the dispatcher seems less severe, relatively speaking, in the 1,500 cps test than in the 2,500 cps test.

In the next test, a server node was taken offline shortly after starting the test. We see that the dispatcher rapidly detects and masks this. Total throughput ended up at 1,451 cps. The loss of the server was nearly undetectable.

Next, we removed two servers from the network, similar to the two-fault scenario in the 2,500 cps environment. This makes the system into a three-node server operating at full capacity. Consequently, it has more difficulty restoring full performance after diagnosis. The average connection rate comes out at 1,221 cps.

In the three fault scenario, similar to our previous three fault scenario, we now examine the case where the servers are overloaded after diagnosis and recovery. This is reflected in the final rate of 1,081 cps. Again, while the four fault case has relatively high average performance, by the end of the test, it was stable at a little over 500 cps, our maximum throughput for one server.

### 500 Connections Per Second

Following the 2,500 and 1,500 cps tests, we examined a 500 cps environment. This gave us the opportunity to examine a highly under utilized system. In fact, we had an "extra" four servers in this configuration since one server alone is capable of servicing a 500 cps load. This fact is reflected in all the fault scenarios. The most severe fault occurred with the dispatcher. In that case, we lost 2,941 connections to timeouts. However, after diagnosing the failure and electing a new dispatcher, throughput returned to a full 500 cps.

In the one, two, three, and four server-fault scenarios, the failure of the server nodes is nearly impossible to see on the graph. The final average throughput was 492.1, 482.2, 468.2, and 448.9 cps as compared with a base case of 499.4. That is, the loss of four out of five nodes over the course of thirty seconds caused a mere 10% reduction in performance.

### Extrapolation

We have demonstrated that given the hardware available at the time of the 1998 Olympic Games (400 MHZ x86), an application-space solution would have been adequate to service the load. To further test the hypothesis that application-space dispatchers operating on commodity systems provide more than adequate performance, we looked at a dispatcher that could have been deployed at the time of the 1996 Olympic Games versus the 1996 Olympic web traffic. Operating under the assumption that the number and type of web servers is not particularly important (owing to the high degree of parallelism, performance grows linearly in this architecture until the dispatcher or network are saturated), the configuration remained the same as previous tests with the exception that the dispatcher node was replaced with a Pentium 133.

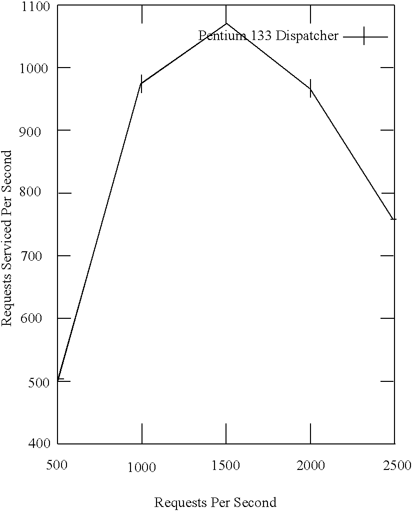

As we see in Figure 4, at 500 and 1,000 cps, we are capable of servicing all the requests. By the time we reach 1,500 cps, we can service just over 1,000. 2,000 and 2,500 cps actually see worse service as the dispatcher becomes congested and packets are dropped, nodes must retransmit, and traffic flows less smoothly. The 1996 games saw, at peak load, 600 cps. That is, our capacity to serve is 1.8 times the actual peak load. In similar fashion, we believe our 1998 vintage hardware is capable of dispatching approximately 3,300 connections per second, again about 1.8 times the actual peak load. While we only have two data points from which to extrapolate, we conjecture that COTS systems will continue to provide performance sufficient to service even the most extreme loads easily.

What is Claimed is:

1. A system responsive to client requests for delivering data via a network to a client, said system comprising: at least one dispatch server receiving the client requests; a plurality of network servers; dispatch software executing in application-space on the dispatch server to selectively assign the client requests to the network servers; and protocol software, executing in application-space on the dispatch server and each of the network servers, to interrelate the dispatch server and network servers as ring members of a logical, token-passing, fault-tolerant ring network, wherein the plurality of network servers are responsive to the dispatch software and the protocol software to deliver the data to the clients in response to the client requests.

2. The system of claim 1, wherein the system is structured according to an Open Source Interconnection (OSI) reference model, wherein the dispatch software performs switching of the client requests at layer 4 of the OSI reference model and translates addresses associated the client requests at layer 2 of the OSI reference model, and wherein the protocol software comprises reconstruction software to coordinate state reconstruction after fault detection.

3. The system of claim 1, wherein the protocol software comprises broadcast messaging software to coordinate broadcast messaging among the ring members.

4. The system of claim 1, wherein the dispatch software executes in application-space on each of the network servers to functionally convert one of the network servers into a new dispatch server after detecting a fault with the dispatch server.

5. The system of claim 1, wherein one of the ring members circulates a self-identifying heartbeat message around the ring network.

6. The system of claim 1, wherein the protocol software includes out-of-band messaging software for coordinating creation and transmission of tokens by the ring members.

7. The system of claim 1, wherein the system is structured according to a multi-layer reference model, wherein the protocol software communicates at any one of the layers of the reference model.

8. The system of claim 7, wherein the reference model is the Open Source Interconnection (OSI) reference model, and wherein the dispatch software performs switching of the client requests at layer 4 of the OSI reference model and translates addresses associated with the client requests at layer 2 of the OSI reference model.

9. The system of claim 7, wherein the reference model is the Open Source Interconnection (OSI) reference model, and wherein the dispatch software performs switching of the client requests at layer 4 of the OSI reference model and translates addresses associated with the client requests at layer 3 of the OSI reference model.

10. The system of claim 7, wherein the reference model is the Open Source Interconnection (OSI) reference model, and wherein the dispatch software performs switching of the client requests at layer 7 of the OSI reference model and then performs switching of the client requests at layer 3 of the OSI reference model.

11. The system of claim 10, wherein the dispatch software includes caching, and wherein said caching is tunable to adjust the delivery of the data to the client whereby a response time to specific client requests is reduced.

12. The system of claim 7, wherein the dispatch software executes in application-space to selectively assign a specific client request to one of the network servers based on the content of the specific client request.

13. The system of claim 1, further comprising packets containing messages, wherein a plurality of the packets simultaneously circulate the ring network, wherein the ring members transmit and receive the packets.

14. The system of claim 1 wherein the protocol software of a specific ring member includes at least one state variable.

15. The system of claim 1 wherein the faults are symmetric-omissive.

16. The system of claim 1 wherein the protocol software includes ring expansion software for adapting to the addition of a new network server to the ring network.

17. A system responsive to client requests for delivering data via a network to a client, said system comprising: at least one dispatch server receiving the client requests; a plurality of network servers; dispatch software executing in application-space on the dispatch server to selectively assign the client requests to the network servers, wherein the system is structured according to an Open Source Interconnection (OSI) reference model, and wherein said dispatch software performs switching of the client requests at layer 4 of the OSI reference model; and protocol software, executing in application-space on the dispatch server and each of the network servers, to interrelate the dispatch server and network servers as ring members of a logical, token-passing, fault-tolerant ring network, wherein the plurality of network servers are responsive to the dispatch software and the protocol software to deliver the data to the clients in response to the client requests.

18. The system of claim 17, wherein the dispatch software translates addresses associated with the client requests at layer 2 of the OSI reference model.

19. The system of claim 17, wherein the dispatch software translates addresses associated with the client requests at layer 3 of the OSI reference model.

20. A system responsive to client requests for delivering data via a network to a client, said system comprising: at least one dispatch server receiving the client requests; a plurality of network servers; dispatch software executing in application-space on the dispatch server to selectively assign the client requests to the network servers, wherein the system is structured according to an Open Source Interconnection (OSI) reference model, wherein the dispatch software performs switching of the client requests at layer 7 of the OSI reference model and then performs switching of the client requests at layer 3 of the OSI reference model; and protocol software, executing in application-space on the dispatch server and each of the network servers, to organize the dispatch server and network servers as ring members of a logical, token-passing, ring network, and to detect a fault of the dispatch server or the network servers, wherein the plurality of network servers are responsive to the dispatch software and the protocol software to deliver the data to the clients in response to the client requests.

21. A method for delivering data to a client in response to client requests for said data via a network having at least one dispatch server and a plurality of network servers, said method comprising the steps of: receiving the client requests; selectively assigning the client requests to the network servers after receiving the client requests; delivering the data to the clients in response to the assigned client requests; organizing the dispatch server and network servers as ring members of a logical, token-passing, ring network; detecting a fault of the dispatch server or the network servers; and recovering from the fault.

22. The method of claim 21, further comprising the step of coordinating broadcast messaging among the ring members.

23. The method of claim 21, wherein the step of selectively assigning comprises the step of switching the client requests at layer 4 of an Open Source Interconnection (OSI) reference model.

24. The method of claim 23, further comprising the step of coordinating state reconstruction after fault detection.

25. The method of claim 24, wherein the step of coordinating state reconstruction includes functionally converting one of the network servers into a new dispatch server after detecting a fault with the dispatch server.

26. The method of claim 25, further comprising the step of the new dispatch server querying the network servers for a list of active connections and entering the list of active connections into a connection map associated with the new dispatch server.

27. The method of claim 21, wherein the protocol software includes packets, said method further comprising the steps of a specific ring member: receiving the packets from a ring member with an address which is numerically smaller and closest to an address of the specific ring member; and transmitting the packets to a ring member with an address which is numerically greater and closest to the address of the specific ring member, wherein a ring member with the numerically smallest address in the ring network receives the packets from a ring member with the numerically greatest address in the ring network, and wherein the ring member with the numerically greatest address in the ring network transmits the packets to the ring member with the numerically smallest address in the ring network.

28. The method of claim 21 wherein the step of selectively assigning the client requests to the network servers comprises the steps of: routing each client request to the dispatch server; determining whether a connection to one of the network servers exists for each client request; creating the connection to one of the network servers if the connection does not exist; recording the connection in a map maintained by the dispatch server; modifying each client request to include an address of the network server associated with the created connection; and forwarding each client request to the network server via the created connection.

29. The method of claim 21 further comprising the step of detecting and recovering from at least one fault by one or more of the ring members.

30. The method of claim 29, wherein the step of detecting and recovering comprises the steps of: detecting the fault by failing to receive communications from the one or more of the ring members during a communications timeout interval; and rebuilding the ring network without the one or more of the ring members.

31. The method of claim 30, wherein the one or more of the ring members includes the dispatch server, further comprising the step of identifying during a broadcast timeout interval a new dispatch server from one of the ring members in the rebuilt ring network.

32. The method of claim 31, wherein the step of selectively assigning comprises the step of switching the client requests at layer 4 of an Open Source Interconnection (OSI) reference model, further comprising the steps of: broadcasting a list of connections maintained prior to the fault in response to a request; receiving the list of connections from each ring member; and updating a connection map maintained by the new dispatch server with the list of connections from each ring member.

33. The method of claim 31 wherein the step of identifying during a broadcast timeout interval a new dispatch server comprises the step of identifying during a broadcast timeout interval a new dispatch server by selecting one of the ring members in the rebuilt ring network with the numerically smallest address in the ring network.

34. The method of claim 21 further comprising the step of adapting to the addition of a new network server to the ring network.

35. A system for delivering data to a client in response to client requests for said data via a network having at least one dispatch server and a plurality of network servers, said system comprising: means for receiving the client requests; means for selectively assigning the client requests to the network servers after receiving the client requests; means for delivering the data to the clients in response to the assigned client requests; means for organizing the dispatch server and network servers as ring members of a logical, token-passing, ring network; means for detecting a fault of the dispatch server or the network servers; and means for recovering from the fault.
